(19) United States
(12) Patent Application Publication
(10) Pub. No.: US 2011/0119316 A1
(43) Pub. Date: May 19, 2011

(54) ABSTRACTION LAYER FOR WORKFLOW CLIENT FOR, E.G., BLU-RAY® DISCS

(75) Inventors: Steven Lawson, Playa del Rey, CA (US); Saravana Prabhu Anbananthan, Los Angeles, CA (US)

(73) Assignees: SONY CORPORATION, Tokyo (JP); SONY PICTURES ENTERTAINMENT INC., Culver City, CA (US)

(21) Appl. No.: 12/771,459

(22) Filed: Apr. 30, 2010

Related U.S. Application Data
(60) Provisional application No. 61/262,645, filed on Nov. 19, 2009.

(51) Int. Cl. G06F 17/30

(52) U.S. Cl. 707/805; 707/E17.01; 707/E17.044

(57) ABSTRACT

Systems and methods are disclosed by which digital content can be: created, assembled, interpreted, displayed, and manipulated, without having to re-engineer the same pattern on multiple projects. An input-driven client program is employed that is agnostic to content details via contract, a contract being a previously specified behavior pattern that is not deviated from on the client side, thereby segregating creative and engineering tasks and eliminating duplicated effort.

### CROSS-REFERENCE TO RELATED APPLICATIONS

This application claims benefit of U.S. Provisional Patent Application No. 61/262,645, filed Nov. 19, 2009, entitled “Content Control Workflow For, E.G., Blu-Ray Disks”, owned by the assignee of the present invention and herein incorporated by reference in its entirety.

### BACKGROUND

Media authoring systems are employed to create media that comply with given standards. For example, a DVD authoring system is used to generate data, such as audio and video data, and other information used to present and access the audio and video data, for placement on a DVD. The data are stored according to standards defined for DVD. Similar, Blu-ray® authoring systems are used to create optical discs storing information according to standards defined by the Blu-ray® Disc Association.

No matter the format, current authoring means for assembling and displaying digital content on various entertainment media are time-consuming and duplicate effort. The duplication is between creative and engineering components on single projects and also between multiple projects. Current practices of implementing templates and using modularity reduce overall time required but do not eliminate duplicated work.

For example, some systems attempt to simplify the development process by automatically generating BD-J code. These applications typically employ some type of graphical user interface to reduce or eliminate the need for a Java® programmer However, many such applications have their own limitations and thus limit the features desired. Other systems and methods, e.g., Blu-ray® authoring systems such as Ensequence on-Q® or Blu-print®, essentially required that a new disc be authored from scratch. While shortcuts exist, e.g., the re-use of file structures or templates, the basic steps remain the same, and the process is time consuming and duplicative. Even more, significant investments in time are required by engineers to create the new disc, even though most aspects of the content for each new disc are creative in nature, not technical.

Moreover, once the design of the media has been finalized, the user's interactive experience is static and unchanging. Certain ancillary aspects may be made dynamic, e.g., a browser window may allow a user to access the internet. However, the user's core interactive experience does not change: the user is merely allowed to perform the functions the designer originally built into the media.

In the field of Blu-ray® disc authoring, one or more authoring modes such as HDMV or BD-J may be employed. For HDMV, features may be configured by the designer such as picture-in-picture, secondary audio, multi-page menu systems, and various menu effects. Using BD-J, Java® programmers may create games, menus, and other programmable features. In the latter, the BD-J application is encapsulated in the Blu-ray® Disc Movie (BDMV) structure. In either case, however, the user performs the HDMV features or runs the BD-J application, and there is no variation from this basic performance routine as delivered on the disc.

### SUMMARY

Certain implementations of the invention provide an improved framework for creating, assembling, interpreting, displaying, and manipulating content, and a particular implementation is formed as a part of a Blu-ray® disc authoring system. The framework takes common actions required on a disc, abstracts these actions to a point where little or no code needs to be written for them to be performed, and then specifies them in a format like XML.

For example, in a Blu-ray® disc or other media authoring systems, there is often a limited subset of actions that can be taken, e.g., change a graphic, start an audio clip, play a video, play an audio clip, reference an external application to the disc, play a slideshow, etc. This can be contrasted to the almost unlimited number of actions that can be programmed to occur upon an HTML button push. However, even the limited subset of actions can be combined in any number of ways. Rather than providing this arbitrarily extensible library of combinations individually, i.e., on a project-by-project basis, by way of separate Java® codings, high-level tags or “contracts” are provided that allow such combinations to be specified and used in a more convenient manner. The contracts are specified behavior patterns that are not deviated from on the client side, and may be specified as, e.g., strings of numeric characters. One such combination may call for a button to be displayed that, when activated, plays a video that is encoded as a playlist of clips of a given format on the Blu-ray® disc. The combination may also include playing a short audio clip, e.g., to make the button beep, or to download a file from a particular website and to play or display the same. For example, for a ‘blink’ effect on a graphic, the contract may call for the Java® layer to be turned off for a set time and for the video layer to be displayed during that set time, during which the video layer portrays the blink effect. Following the blink effect, the Java® layer is turned back on. In this example, an XML timer object may be employed, which is bound to an action such as video playback. The same could in addition, or alternatively, be bound to a download action. The download action may cause control to jump to an entirely different application following an effect playback.

In use, a client system such as a media player reads details of the content and the various contracts regarding user interface details including, but not limited to, framework components such as display, menu, and navigation components. The client system may also read details of tasks required by the workflow client from an intermediate medium, e.g., a file, stream, or other data source. The user interface is assembled and reacts according to user input and performs tasks according to the specified contracts. The workflow client may be updated to alter or add or remove contracts and display or other elements. One way of updating the workflow client is by accessing an online resource. In the Blu-ray® context, online resources are accessed using the BD-Live® hardware capability.

In one aspect, the invention is directed towards a computing system configurable to create a desired computer-readable medium. The system includes a processor, memory in communication with the processor bearing computer-readable instructions capable of creating an editing environment for a workflow client file, memory in communication with the processor capable of storing the workflow client file, memory in communication with the processor capable of storing one or more asset files referenced by the workflow client file, and a recordable media device capable of recording the workflow client file and the one or more asset files onto a computer-readable medium in an appropriate format to be interpreted and played back by a media player.

Implementations of the computing system invention may include one or more of the following. The workflow client, which may be set forth in XML program instructions, may provide a menu or a navigational component for a computer-readable medium, and may further set forth the menu or navigational component using a combination of core functionality components for the computer-readable medium. The editing environment for a workflow client file may be a graphical user interface, may form a portion of a media authoring system, or both.

In another aspect, the invention is directed towards a computer-implemented method of creating a computer-readable medium. Steps of the method include creating an editing environment for a workflow client file, accepting user input to create and edit the workflow client file, accepting user input and associating one or more asset files with the workflow client file; and recording the workflow client file and the one or more asset files onto a computer-readable medium in an appropriate format to be interpreted and played back by a media player. In a further aspect, the invention is directed towards a computer-readable medium, including instructions for causing a computer to execute the above method.

In yet another aspect, the invention is directed towards a method of updating a media player menu or navigational component, including steps of receiving a computer-readable medium, comparing a workflow client file on the computer-readable medium to a workflow client file on an online resource, and if the workflow client file on the computer-readable medium is not as recent as the workflow client file on the online resource, then downloading the workflow client file from the online resource to a local storage area on the media player, such that the workflow client file controls a display of menu and navigational components for a computer-readable medium for playback in a media player.

Implementations of the method of the invention may include one or more of the following. The workflow client file from the online resource may further reference at least one asset previously referenced by the workflow client file on the computer-readable medium. The workflow client file from the online resource may further reference at least one asset not previously referenced by the workflow client file on the computer-readable medium. The method may further include comparing a workflow client file on the computer-readable medium to a workflow client file stored in a local storage, and if the workflow client file on the computer-readable medium is not as recent as the workflow client file on the local storage, then using the workflow client file from the local storage to control the display of menu and navigational components. In a further aspect, the invention is directed towards a computer-readable medium, including instructions for causing a computer to execute the above method.

In a further aspect, the invention is directed towards a media player system, including a processor, memory in communication with the processor bearing computer-readable instructions capable of reading a workflow client file from a computer-readable medium; memory in communication with the processor capable of storing the workflow client file; memory in communication with the processor bearing computer-readable instructions capable of causing the media player system to access an online resource to determine if a more recent version of the workflow client file is available, and memory in communication with the processor bearing computer-readable instructions capable of, if a more recent version of the workflow client file is available, causing the media player system to replace the workflow client file from the computer-readable medium with the workflow client file from the online resource.

Implementations of the media player system invention may include one or more of the following. The workflow client file from the online resource may further reference at least one asset previously referenced by the workflow client file on the computer-readable medium. The workflow client file from the online resource may further reference at least one asset not previously referenced by the workflow client file on the computer-readable medium. The method may further include comparing a workflow client file on the computer-readable medium to a workflow client file stored in a local storage, and if the workflow client file on the computer-readable medium is not as recent as the workflow client file on the local storage, then using the workflow client file from the local storage to control the display of menu and navigational components. In a further aspect, the invention is directed towards a computer-readable medium, including instructions for causing a computer to execute the above method.

Advantages of certain implementations of the systems and methods may include one or more of the below. The systems and methods may provide increased separation between content creation and media authoring, and thereby allows media creation with lessened engineering investment. The system also decouples display and functionality, allowing user-defined functionality to be included along with basic or core functionality. In this way, a user may package their own set of functional components on a level above the core functionality library of the disc. For example, a user-defined slideshow function may be copied across several discs of a series but may include different images. The slideshow package then references and combines more fundamental core functionality actions such as displaying an image in a given location. When a new slideshow is desired, the asset files are simply replaced and, if desired, e.g., repositioned. In this way, an application is created that performs similar functionality but appears completely different.

Other advantages of certain implementations include the following. Content may be authored strictly by creative components. Display, navigation, and task details can be manipulated via the interpreted medium. Engineering resources need only be allocated to improve or alter the interpretive behavior of the client, thereby optimizing content authoring workflow. While the core functionality of certain media types may be limited to a small number of actions, e.g., play a video clip or slideshow, the ability to combine core functionalities leads to significant expandability. Content as well as menu and navigational functionality can evolve over time since updated or new workflows or content can be downloaded and employed. The improved system can be used in conjunction with or as a tool within authoring tools such as Ensequence on-Q® or Blu-print®. Besides employment within an authoring system to create a given project, the framework may be employed to create other frameworks on which projects, or series of projects, may be based. The system may include a graphical user interface in order to allow more simplified creation of the workflow client. As the system operates on an abstraction layer that is independent of the underlying Java® layer, it is platform-independent and may be implemented in numerous ways, including on mobile platforms with a suitable mobile interpreter. The system and method may be expandable: as new functionality of the target media player becomes available, new contracts may be created to take advantage of the same. Alternatively, the workflow client may stay the same and the underlying layer, e.g., an underlying Java® object, may be modified. The system and method may be used in conjunction with current tools, e.g., Blu-print®, to create a Blu-ray®-compliant product appropriate for playback on a Blu-ray® player.

Other advantages of certain implementations will become apparent from the below description, including the figures and claims.

### BRIEF DESCRIPTION OF THE DRAWINGS

Like reference numerals denote like elements throughout.

FIG. 1 illustrates a schematic of a media authoring system.

FIG. 2 illustrates schematically a workflow client and exemplary referenced files and resources.

FIG. 3 illustrates organization of files in a Blu-ray® disc.

FIG. 4 illustrates a system model of BD-J applications.

FIG. 5 illustrates a client system, e.g., a media player such as a Blu-ray® player, and its relation to a display device, online resources, and intermediate media.

FIG. 6 is a flowchart of one implementation of the described method. In this implementation, a computer-readable medium such as a Blu-ray® disc is created with a workflow client. The workflow client or other disc assets can be updated or added to using an online resource.

FIG. 7 is a flowchart of another implementation of the described method. In this implementation, a computer-readable medium such as a Blu-ray® disc is created such that generally only high-level elements, termed contracts, need be manipulated by the user.

FIG. 8 illustrates an exemplary structure of a workflow client, illustrating the structure of contracts built from core functionality components.

FIG. 9 is a sample XML code section defining the behavior of an exemplary Special Features option in a workflow client.

FIG. 10 illustrates an exemplary computing environment, e.g., that of the disclosed workstation or client system.

### DESCRIPTION

In the disclosed systems and methods, a workflow client is created that is then used to drive consumption of the media and associated assets. The workflow client includes details about display and navigation, e.g., buttons bound to an XML framework that perform various functions. The workflow client also performs tasks required on the medium from an intermediate or external medium, e.g., a file on a hard drive, streamed data, online data source, and so on. A user interface is assembled via the workflow client and then acts in a normal fashion, according to user or other input. In this way, content can be authored solely by manipulation of creative components such as those related to navigation and display, minimizing the need for additional engineering input.

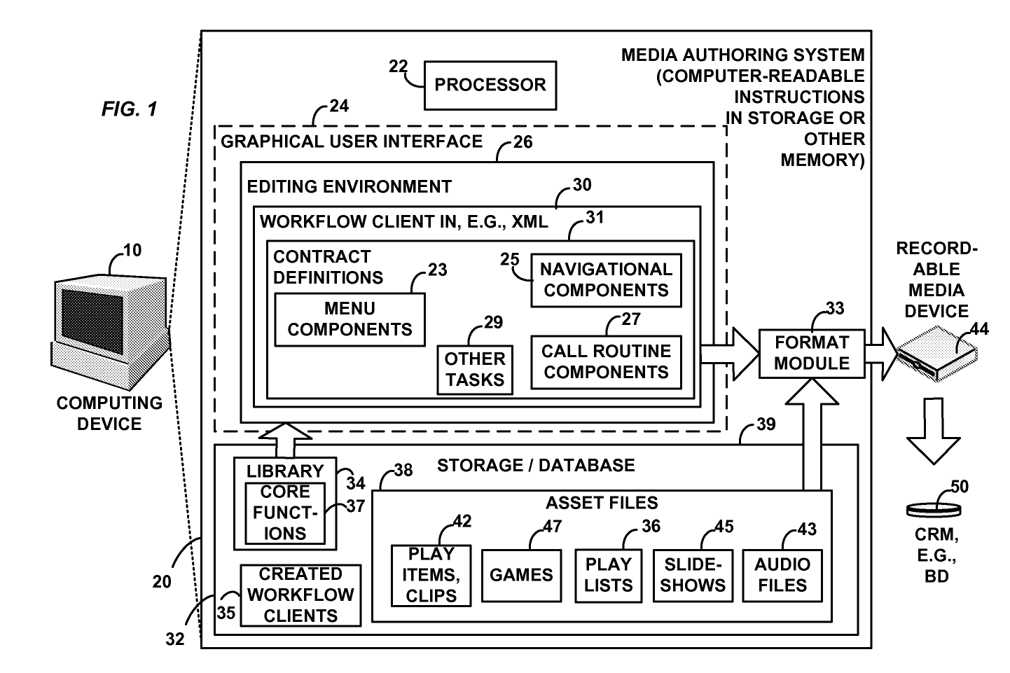

Referring to FIG. 1, a workstation 10 is illustrated that may be employed as part of a media authoring system 20. The workstation 10 includes a processor 22 and an editing environment 26. The workstation 10 may be any of a number of types, from simple computing systems to complex multimedia editing machines. The editing environment may conveniently include a user-friendly graphical environment 24, e.g., an optional graphical user interface 24, but simple editing systems may also be employed, so long as the same are capable of creating and editing a workflow client 30 in an appropriate format that may be interpreted by an underlying layer, e.g., a Java® layer, which is in turn interpretable by a media player. In this description, XML is employed as a convenient workflow client format, although any language may be employed, so long as the same is capable of being implemented on an underlying client system, e.g., a media player. For example, an XML workflow may be implemented on a Blu-ray® disc so long as the XML may be interpreted by the BD-J environment of the Blu-ray® player.

The editing environment may be implemented as a two-layer system. The lower layer is a navigational framework that allows the user to manipulate various objects, e.g., buttons or other widgets. Above this navigational framework may be a framework or dictionary of common tasks. In the case of Blu-ray®, the tasks may be “Play Video”, “Display Graphics”, and the like. An entire application may be created using this layered framework employing only the high-level language of the workflow client, e.g., XML.

The editing environment 26 is employed for creating and editing the workflow client 30, and may be a simple text editor or an advanced graphical environment. The functionality of existing authoring systems may be leveraged in some cases to provide an editor for workflow clients. A workflow client 30 is created within the editing environment 26 and the same may include contract definitions 31 which may be related to menu components 23, navigational components 25, call routine components 27, and other tasks 29. Other types of contracts will also be understood given this description.

The media authoring system 20 may also include a storage area 32, which may be, e.g., part of a database. Within the storage area 32 may be a library 34, in which may be stored routines, functions, classes, or other reusable components. Code for the core functionality components 37 may also be stored in the library 34. The storage area may include various asset files 38 as well, which may include one or more playlists 36. Playlists include collections of playing intervals of clips that indicate which portion of the clip to play and when to play the clip. The storage area 38 may include numerous other types of content as asset files, including games 37, the play items or clips 42 themselves, slideshows 45, and audio files 43. The storage area 38 will be understood to include any number of other items and files as well, including computer-readable instructions for running the underlying applications, as well as storage for created workflow clients 35. The storage area 38 may be situated on one or more hard drives or flash drives, or on any other type of computer-readable media as is known or will become known.

Once ready for distribution, the playlists 36 and assets 38, along with the workflow client 30, may be retrieved, formatted if necessary in format module 33, and stored or “burned” onto a computer-readable medium 50, which is shown in FIG. 1 as a Blu-ray® disc or “BD”, using a recordable media device, e.g., a writable disc drive 44. It will be understood that numerous other types of computer-readable media may also be employed for this purpose. Moreover, in this description, the terms BD and computer-readable medium are both employed, depending on context.

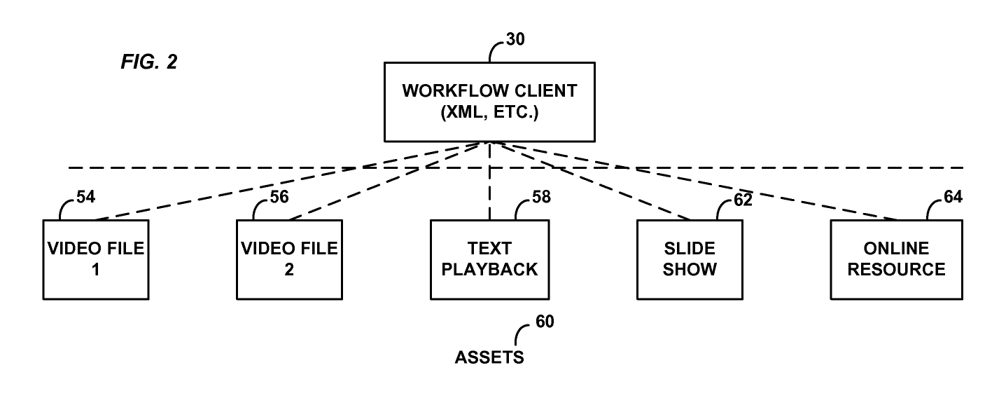

FIG. 2 illustrates a workflow client file 30 as well as various asset files 60, which are referenced by the workflow client 30. The workflow client 30 may be constructed in a number of languages or formats as discussed above, including, e.g., XML. The workflow client 30 generally provides a step-by-step order of presentation of the various assets referenced by the workflow, in terms of both the content to be presented and the format for presentation. In other words, the workflow client 30 governs what is to be presented and the way it is presented. When a user provides an input, e.g., activates a button on a remote control of the media player, the workflow accepts an input according to the activated button and transfers control if necessary to a routine called by the activated button.

In FIG. 2, the workflow client 30 references a number of files, including first and second video files 54 and 56, respectively. The first and second video files may represent a feature film and a trailer, for example. The workflow client 30 may also access a text playback file 58, e.g., text-based subtitles, dynamically-generated game scores, video runtimes, etc. The workflow client 30 may also access a slideshow 62, e.g., a set of pictures illustrating the making of the feature film.

Besides these assets 60 that are present on the BD itself, the workflow client may also access an online resource 64 to retrieve online content. While there is no limit to the ways one can retrieve online content, in the Blu-ray® context the BD-Live® system is used, which enables users to access content using an internet-connected BD player. Online resources then allow users to download or retrieve updated content, updated formats for BD content presentation, as well as special features such as ringtones/wallpaper downloads, peer-to-peer interactions, live events, and gaming activities. While the BD-Live® system has been discussed here for the Blu-ray® context, other online resources may also be employed in other contexts.

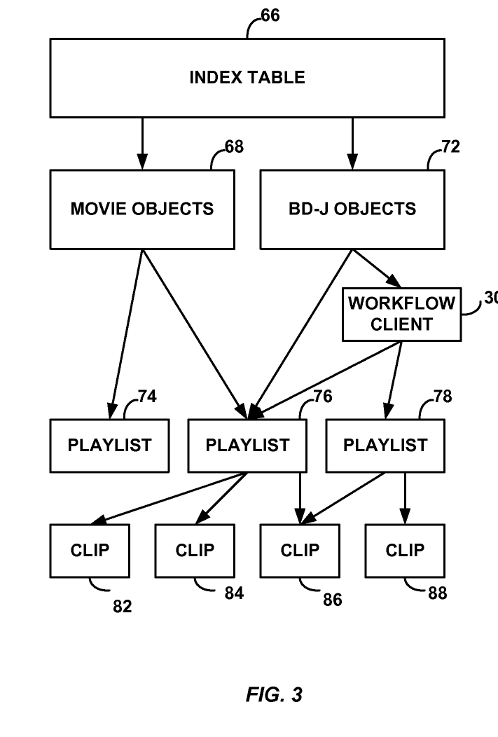

FIG. 3 illustrates a structure of an exemplary computer-readable medium, e.g., a BD. An index table 66 provides a starting point and may be thought of as being at the highest level of the disc. Generally, the index table 66 lists and in some cases can reference one or more movie objects 68 and one or more BD-J objects (BDJOs) 72. The set of movie objects 68 refers to HDMV objects which run in the execution environment of the HDMV mode. Similarly, the set of BDJOs 72 refer to BDJOs that run in the procedural environment of the BD-J mode. The movie objects 68 and BD-J objects 72 can each perform a number of functions, including launching playlists 74, 76, and 78, which in turn include and run one or more playitems or clips 82, 84, 86, or 88.

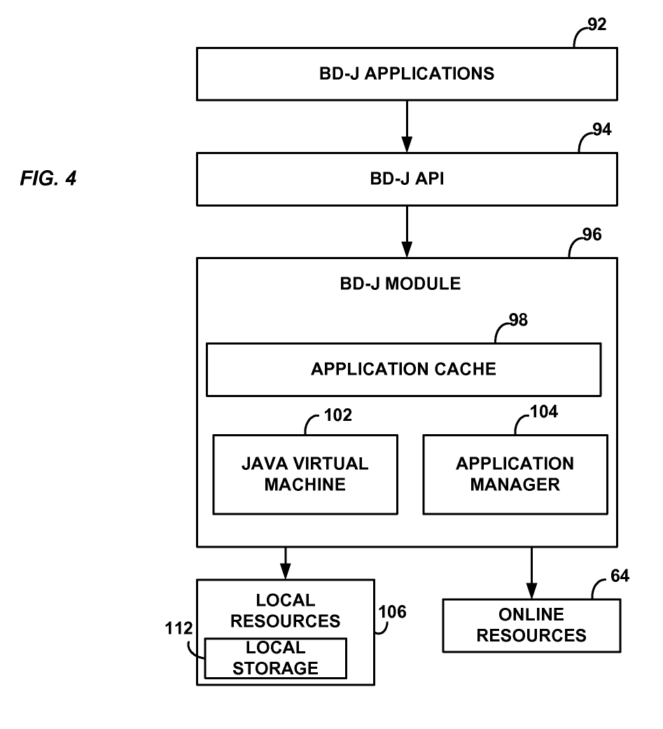

BD-J objects 72 are described in more detail in the system model of FIG. 4, which also shows their relation to local storage in a media player and online content. In particular, BD-J objects 72 refer to Java® applications and even more particularly to BD-J applications 92. The BD-J applications 92 employ, e.g., Xlets, as are known, and these employ the same multiple state definitions as, e.g., applets. The BD-J applications 92 interact with a user to control a media player such as a Blu-ray® player through the BD-J API 94. The BD-J API 94 provides a number of functions and objects to communicate with the player, and is used by BD-J applications 92 to load files, access the network, control playback, and perform other player tasks.

A workflow client file 30 may be launched from a BD-J object 72, this workflow client file 30 then controlling placement and operation of the menu, navigational, and other components.

A BD-J module 96 is situated between the BD-J API 94 and the local resources 106 of the player itself, and provides an abstraction layer between the application and the player. The BD-J module 96 includes an Application Manager 104 which determines what BD-J application is running as well as a Java® Virtual Machine 102 on which to run the BD-J application. The BD-J module 96 controls access to the various resources accessible to the player, such as the local resources 106 and an online resource 64.

The local resources 106 include the base capabilities of the player, such as decoding, memory management, and player control of sounds, video, and the like. The local resources may also include data previously downloaded and stored from other discs. Other resources that may be accessed include specific Java® Archives (JARs) that in turn refer to code that controls the disc playback. In general, all files required to run the application will be loaded into an application cache, which provides a pre-load buffer for the application.

The BD-J module may also access the online resource 64. Multiple online resources may be accessed in some implementations. The same may provide content and workflow clients directly or in a peer-to-peer fashion. The online resource 64 may be leveraged to provided updated or refreshed content, e.g., advertisements for upcoming movies, advertising content for products, different or revised menu, display, and navigational environments for the BD content, additional audio or subtitle streams, bonus videos, BD-J applications, or the like. In so doing, bootstrap functionality may be leveraged, in which online resource 64 is checked for updates or additional content upon disc loading.

In particular, online resource 64 may be polled to determine if a new or updated workflow client is available and may be downloaded. In one implementation, an updated workflow client may be downloaded to provide a new user interface and/or menu and navigational environment for a BD. For example, a new user interface may be downloaded and used to commemorate a special anniversary edition of a feature film. In another example, the user interface may commemorate a holiday within the region in which the BD is prevalent. In still other cases, a custom user interface may be provided and distributed or sold. Distribution may be limited by constraining the download to a certain number of BD players, a certain geographic area as determined by IP address, or to certain users, again determined by IP address. In accessing the online resource 64, an appropriate authentication process may be employed, including application signing using permissions defined in a permission request file. New workflow clients and other downloaded content may be stored in a local storage area of the client system, illustrated in FIG. 4 as local storage 112.

Besides downloading additional content, online resource 64 may also be the recipient of uploaded information, content, or other data from the client system. Such uploaded information may include high game scores, bookmarks, or the like.

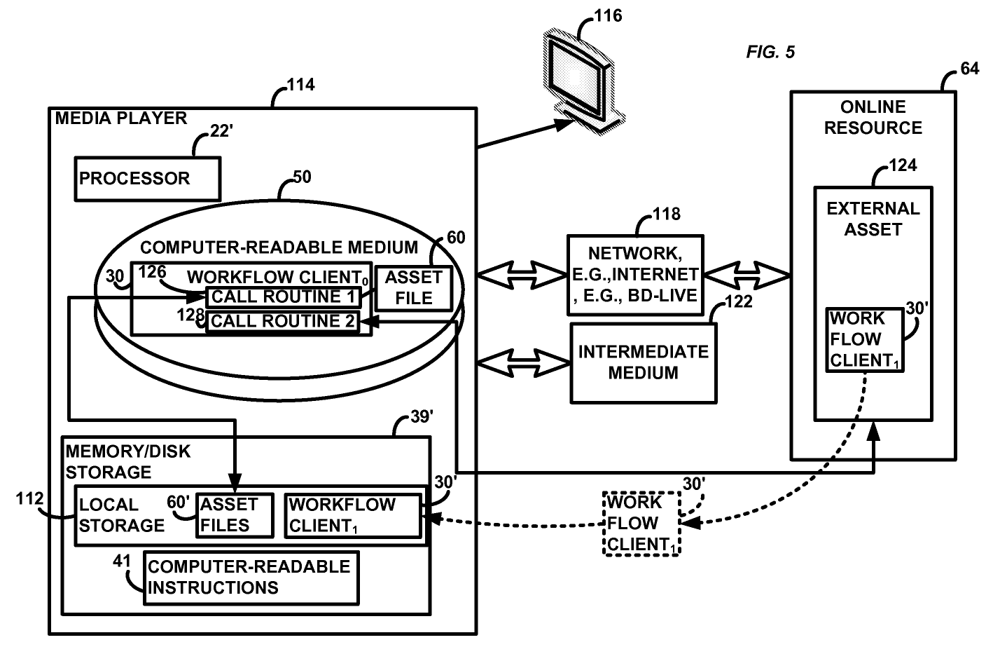

FIG. 5 illustrates a client system 114, e.g., a media player such as a Blu-ray® player, and its relation to a display device 116, online resource 64, and intermediate media 122. A client system 114 is illustrated having a computer-readable medium 50 disposed therein. Audiovisual output from the client system 114 may be seen on the display 116.

The computer-readable medium 50 has stored thereon a workflow client file 30. The workflow client file 30 accesses one or more asset files 60 on the computer-readable medium 50. The workflow client file 30 accesses an asset file 60 using an appropriate call routine 126. The workflow client file 30 may also access one or more files in local storage 112 in the client system 114. Such local storage 112 files are typically stored within a memory or disc storage area 39 within the media player 114. A memory or disc storage area 39 may also be employed for storage of various computer-readable instructions 41, including those used for reading, storing, replacing workflow clients, accessing online resources, comparing workflow client versions, referencing assets, authenticating and providing permissions, and so on.

Where files in local storage are accessed or referenced, the call routine 126 may include if necessary an appropriate credentialing process. The workflow client 30 may also use call routine 128 for the client system 114 to access an online resource 64, and in particular an external asset 124 on the online resource 64. The connection may be made by any sort of network connection 118, including using the internet, and including use of services specifically for such connections, like BD-Live®. In accessing the external asset 124, the client system 114 may employ an appropriate authentication process, including application signing using permissions defined in a permission request file.

One type of file that may be accessed, as described below, is an updated workflow client 30′. If available and downloaded, the same may be stored as workflow client 30′ in local storage 112 in a memory or disc storage area 39′.

In addition to accessing online resources or assets stored on the computer-readable medium 50, the client system 114 may also access an intermediate medium 122, e.g., an external drive or other source of content.

In any case, a call routine may access any number of functions; for example, in the Blu-ray® scenario, it may access any arbitrarily-written Java® application.

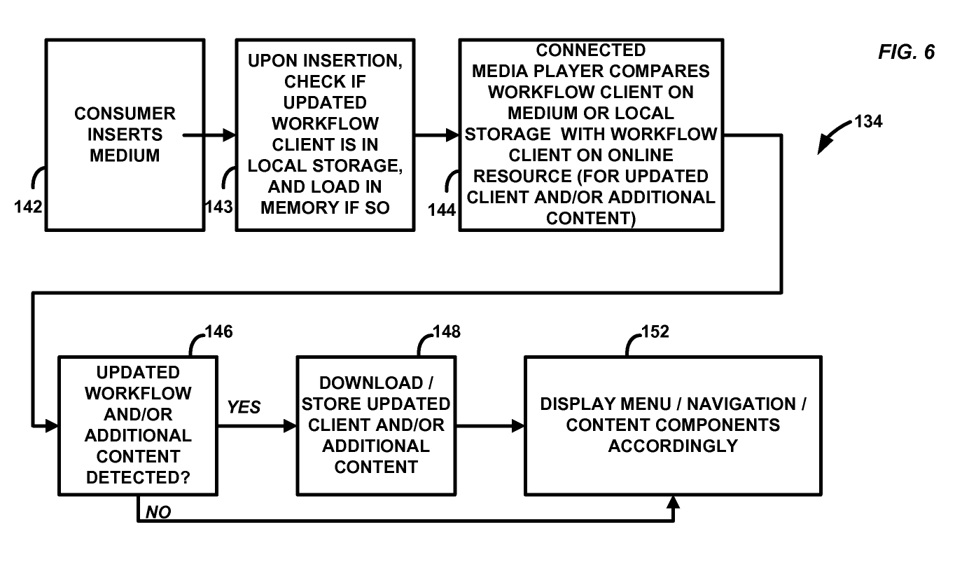

FIG. 6 is a flowchart of one implementation of the described method. A consumer inserts a computer-readable medium such as the BD (step 142), e.g., in a computer, media player, or the like. Upon insertion, the system may compare a workflow client on the computer-readable medium with a workflow client stored in local storage (step 143). If a workflow client stored in local storage is updated or more recent compared to that on the computer-readable medium, then the workflow client from local storage is used to control and display menu and navigational components.

If the BD is played in a device that has a connection to the Internet, the BD may cause the connected device to poll an online resource, e.g., using BD-Live® in the Blu-ray® context, for an updated workflow client, or for additional content (step 144). The detection of an updated workflow client or additional content may be by way of comparing version numbers and selecting the workflow client with the highest version number as the updated one or the like (step 146). If no updated workflow clients or additional content is detected (step 146), then the workflow client causes the display of the menu and navigation structure accordingly (step 152). If an updated workflow client or additional content is detected (step 146), then the same may be downloaded and stored (step 148) in local storage and used for display (step 152). In the BD context, new workflow clients may be stored in a binding unit data area, and may be tied to the disc via a manifest file, so that when the disc is reinserted, the new workflow client is loaded rather than the prior workflow client already present on the disc.

The downloaded workflow client is then employed to alter the user experience (step 152). The new or updated workflow client may reference previously installed (or otherwise accessible) assets, components such as framework components, or other constituent files. Alternatively, the same may access and reference only updated constituent files, whether the updated files were installed before, after, or at the same time as the workflow client. It will be understood that combinations of these may also be referenced. In this way, menu or navigational components may be altered, additional content may become available, a downloaded game may be played, and so on. In so doing, the altered or new workflow client file is run and may access any number of different constituent files, e.g., to provide new buttons, and/or may alter the presentation of the same constituent files. In particular, the workflow client is interpreted, the menu and navigational components are displayed, and whatever actions are bound to the workflow client are taken.

It is noted that in the above method, only the workflow client need be downloaded from an online resource. There is not necessarily a requirement to access and download any particular additional framework components, which would in turn define what the various actions are. That is, there is no need to download entire scripts or, e.g., Java® programs, to implement a change in the appearance and functionality. It is also noted that if no network connection is available, the most recent version of the workflow client, whether located on the computer-readable medium or in local storage, may be used for display. Typically, this will be in local storage; however, a later release of a computer-readable medium, e.g., an anniversary edition, may incorporate a more updated version of a workflow client than an earlier computer-readable medium, and in this case the computer-readable version may be more recent or updated.

In another aspect of the system and method, content authoring of computer-readable media is made significantly easier by employment of a system and method according to an implementation of the invention.

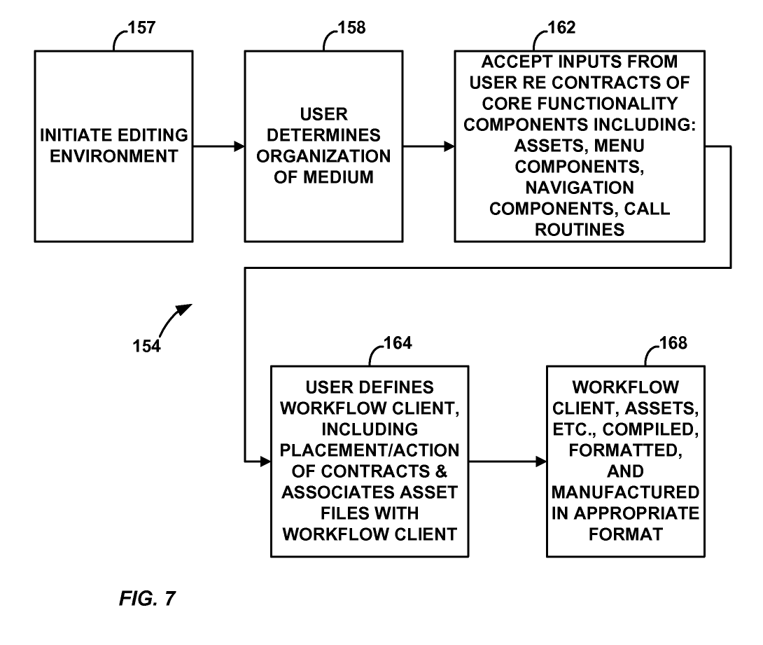

FIG. 7 is a flowchart of an implementation of the described method. In this implementation, a computer-readable medium such as a Blu-ray® disc is created such that generally only high-level elements, termed contracts, need be manipulated by the creator. The user, who is typically a non-programmer, can utilize a high-level framework to create a computer-readable medium without significant programming. Such a user may employ and modify an existing workflow client or may create a new workflow client from scratch.

A first step of the method 154 is to initiate the editing environment (step 157). A next step for a user, e.g., the content author, is to determine the organization of the desired computer-readable medium, e.g., the BD disc (step 158). The user then organizes, and the system accepts inputs regarding, all the needed files, including assets, menu components, navigation components, call routines, and the like (step 162). This step includes definition or inclusion of contracts, which are specified behaviors. For example, a contract may state “display a button of this type”, “play this clip”, or “play this playlist”, which are desired actions that would typically require a significant degree of coding. The contracts thus define, constitute, and cause the desired behavior, in many cases upon the occurrence of a designated user input. In any case, the user defines the placement and action of the contracts within the editing environment (step 164) and also associates asset files with the project. In a graphical editing environment, the contracts may be indicated by icons or codes that may be easily manipulated. In one implementation, contracts for buttons may be dragged and dropped onto a proposed menu page. Contracts may be defined for actions, and may be stacked in any number of ways. For example, a contract may call for, upon user input, playing a trailer for a sequel and then immediately launching the main feature. The expandability of this system is such that any number of desired actions may be combined or configured, and yet the designer need not have any significant engineering knowledge.

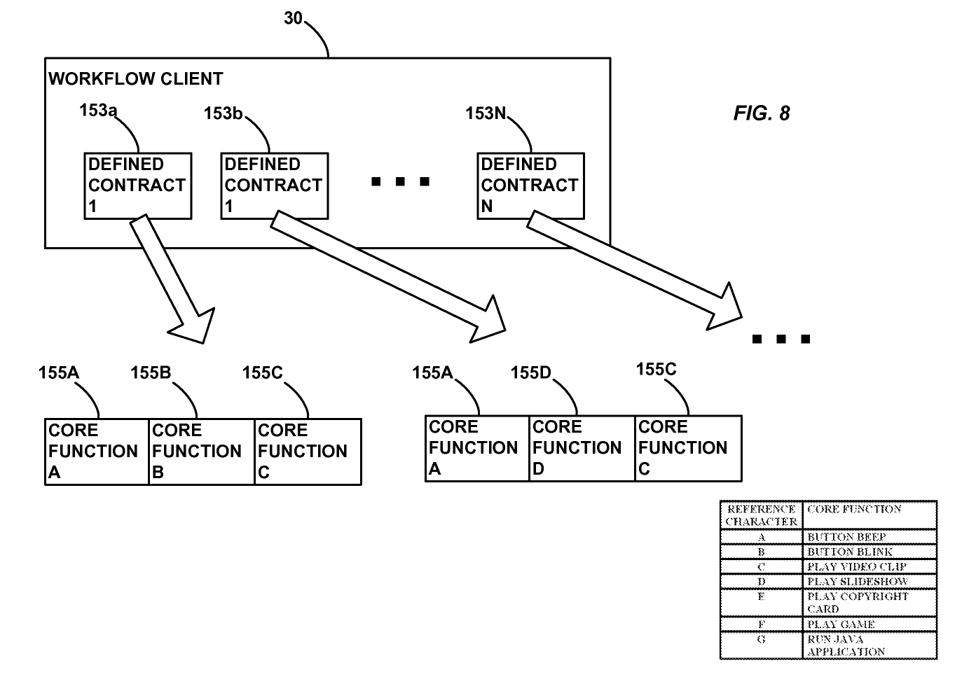

FIG. 8 illustrates a schematic depiction of an exemplary workflow client file having contracts defined therein, as well as core functionality components that make up the contracts. In particular, a workflow client 30 is illustrated having a number of defined contracts 153a-153N. The contracts represent specified behaviors and may be manifested as buttons, widgets, or the like. The specified behaviors of the contracts are generally built up from core functionality components. For example, contract 153a is built up from core functionality component A (155A), core functionality component B (155B), and core functionality component C (155C). As another example, contract 153b is built up from core functionality component A (155A), core functionality component D (155D), and core functionality component C (155C). A table is given of the components. For example, core functionality component A may be a button beep, core functionality component B may be a button blink, core functionality component C may be to play a video clip, core functionality component D may be to show a slideshow, and so on. Contract 153a then provides a desired function: upon activation, a button beeps and blinks, and a video clip is played. Contract 153b provides a different function: a button beeps, a slideshow is played, and then a video clip is played. Contract 153b may be employed when a button activation is intended to cause a slideshow of coming scenes followed by a video clip.

After the above steps, a tool may be employed to prepare the assets, e.g., video streams, and ensure the same are named, configured, and formatted properly. Following this step, the workflow client and assets may be compiled and manufactured as a computer-readable medium (step 168).

Once the contracts and their actions are defined, the same may be employed to make up the workflow client. For example, a user may construct a workflow client file that calls for certain content items to be displayed in a certain order and that also describes the layout of the content items. In so doing, the user may modify or reuse an existing workflow, e.g., by modifying contracts or by changing the actual content that the workflow client references or points to. In situations where a desired collection of existing contracts is insufficient to perform a desired task, an engineer may be employed to create new core functionality components or to modify existing ones; however, this step may require programming knowledge in the underlying environment, e.g., Java®.

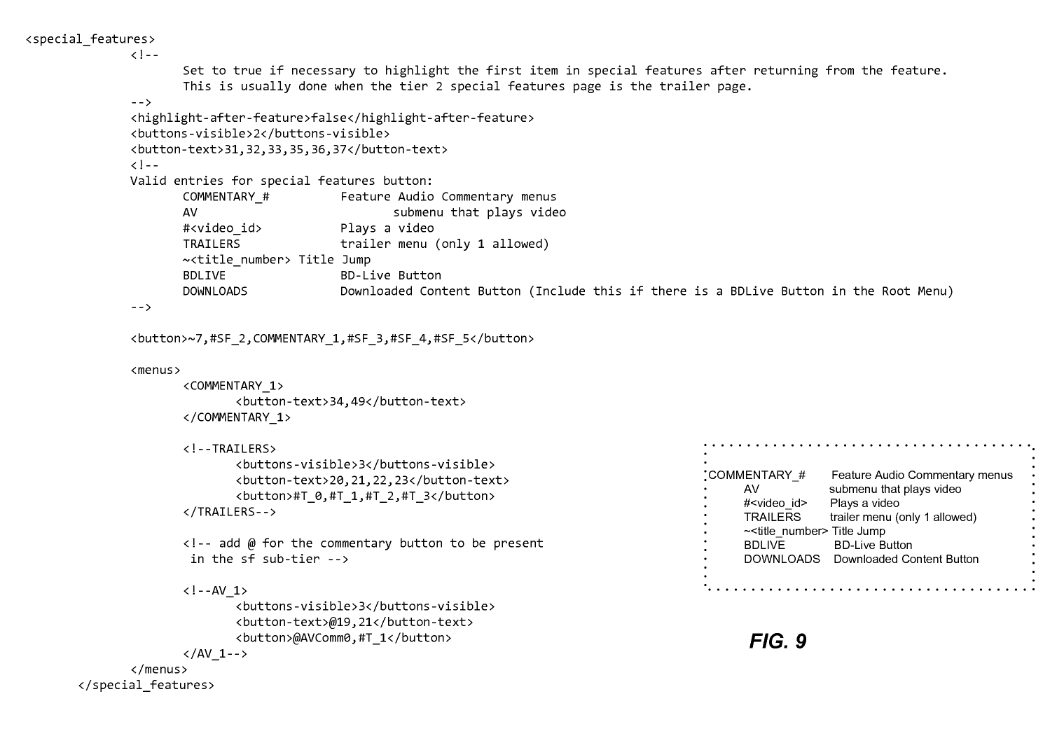

FIG. 9 illustrates an exemplary code section that defines the behavior of a Blu-ray® disc “Special Features” option. This section defines behavior for items including commentary, the video files, trailers, BD-Live®, and downloads. The inset shows the structure and behavior of the <button> tag.

While the system and method have been described in the context of Blu-ray® discs, they may apply to any number of other computer-readable media. For example, in addition to BD media, the framework may be employed to create, assemble, interpret, display, and manipulate numerous other types of media, including, e.g., implementing a user interface for a set-top VOD player.

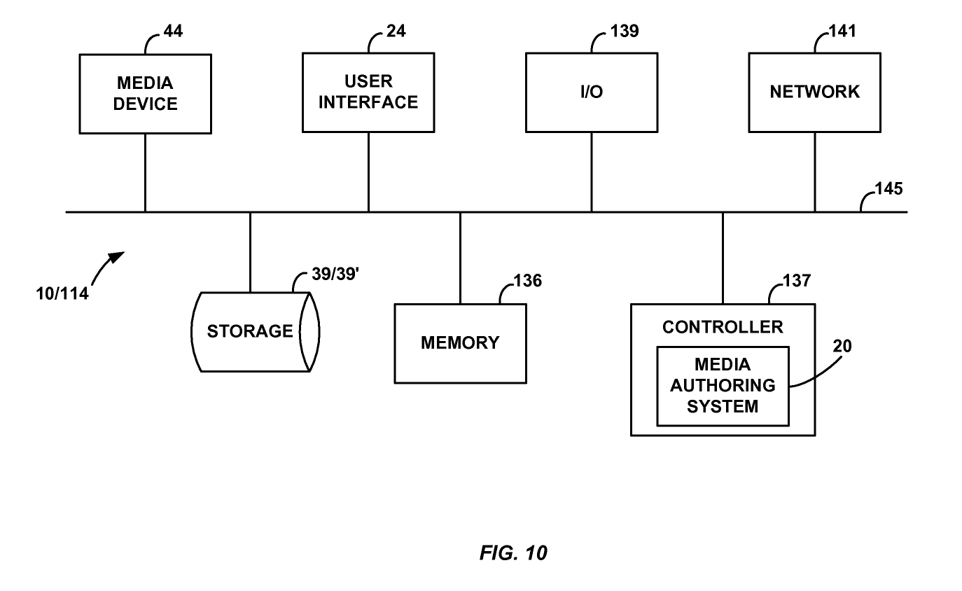

One implementation includes one or more programmable processors and corresponding computer system components to store and execute computer instructions, such as to provide the framework for creating, assembling, interpreting, displaying, and manipulating content. For example, and referring to FIG. 10, a representation of an exemplary computing environment, e.g., a workstation 10, is illustrated. A similar description will apply to media player 114, but in that case a media authoring system 20 would not be present. A user can employ the workstation 10 to author a computer-readable medium 50 in a particularly convenient fashion. The workstation 10 executes an authoring system 20 which receives BD-ROM data as an input and outputs a computer-readable medium such as a BD. In one example, the authoring system 20 creates a BD with assets and a workflow client to provide a desired viewing experience for a user, including a viewing experience that can be updated even after the BD has been purchased by the user.

In FIG. 10, the workstation 10 includes a controller 137, a memory 136, storage 39, a media device 44, a user interface 24, an input/output (I/O) interface 139, and a network interface 141. These components are interconnected by a common bus 145. Alternatively, different connection configurations can be used, such as a star pattern with the controller at the center.

The controller 137 includes a programmable processor and controls the operation of the workstation 10 and its components. The controller 137 loads instructions from the memory 136 or an embedded controller memory (not shown) and executes these instructions to control the system. In its execution, the controller 137 may provide the BD authoring system 20 as, in part, a software system. Alternatively, this service can be implemented as separate components in the controller 137 or the workstation 10.

Memory 136 stores data temporarily for use by the other components of the workstation 10. In one implementation, memory 136 is implemented as RAM. In other implementations, memory 136 also includes long-term or permanent memory, such as flash memory and/or ROM.

Storage 39 stores data temporarily or long term for use by other components of the workstation 10, such as for storing BD data used by the authoring system 20. In one implementation, storage 39 is a hard disc drive.

The media device 44 receives removable media and reads and/or writes data to the inserted media. In one implementation, the media device 44 is an optical disc drive or disc burner, e.g., a writable Blu-ray® drive.

A user interface 24 includes components for accepting user input from the user of the workstation 10 and presenting information to the user. In one implementation, the user interface 24 includes a keyboard, a mouse, audio speakers, and a display. The controller 137 uses input from the user to adjust the operation of the workstation 10.

The I/O interface 139 includes one or more I/O ports to connect to corresponding I/O devices, such as external storage or supplemental devices (e.g., a printer or a PDA). In one implementation, the ports of the I/O interface 139 include ports such as: USB ports, PCMCIA ports, serial ports, and/or parallel ports. In another implementation, the I/O interface 139 includes a wireless interface for wireless communication with external devices.

The network interface 141 includes a wired and/or wireless network connection, such as an RJ-45 or “Wi-Fi” interface (802.11) supporting an Ethernet connection. Numerous other types of network connections will be understood to be possible, including WiMax, 3G or 4G, 802.15 protocols, 802.16 protocols, satellite, Bluetooth®, or the like.

The workstation 10 includes additional hardware and software typical of workstations (e.g., power, cooling, operating system), though these components are not specifically shown in the figure for simplicity. In other implementations, different configurations of the workstation can be used (e.g., different bus or storage configurations or a multi-processor configuration).

Various illustrative implementations of the present invention have been described. However, one of ordinary skill in the art will recognize that additional implementations are also possible and within the scope of the present invention. For example, although the disc authoring system has been described in terms of the BD format, the system can be used to author discs or media in formats other than in the BD format. Conversely, the system can be employed in the context of a Blu-ray® platform technology, where Blu-ray® technology is employed but where the source or target of files is not a BD. In this case, delivery of content such as workflows and asset files may be initially by way of a delivery mechanism such as the internet or other network, rather than via BD. Other delivery mechanisms will also be understood. The workflow client or asset files may be updated, replaced, or supplemented using online resources as before. However, it is generally not BD insertion and consequent playback that initiates a call for updates, but rather playback of the stored content corresponding to the workflow client. In this implementation, the workflow client would be stored onto a computer-readable medium upon creation and transmitted over the network in an appropriate format to be stored, interpreted, and played back by a media player.

The system may be particularly useful in situations where there are many combinations of desired functionality, but where the number of displayable elements is limited. The system and method may be used to implement changes to user interfaces besides media player displays. For example, changes may be made to browser UIs by downloading new workflow clients for a browser. In some cases, rather than downloading new or editing prior workflow clients, the user may be enabled to modify the same on a custom basis. Such edited workflow clients would generally be stored in local storage on the media player.

Accordingly, the present invention is not limited to only those implementations described above.

What is claimed is:

1. A computing system configurable to create a desired computer-readable medium, comprising:
a. a processor;
b. memory in communication with the processor bearing computer-readable instructions capable of creating an editing environment for a workflow client file;
c. memory in communication with the processor capable of storing the workflow client file;
d. memory in communication with the processor capable of storing one or more asset files referenced by the workflow client file; and
e. a recordable media device capable of recording the workflow client file and the one or more asset files onto a computer-readable medium in an appropriate format to be interpreted and played back by a media player.

2. The computing system of claim 1, wherein the workflow client provides a menu or a navigational component for a computer-readable medium.

3. The computing system of claim 2, wherein the workflow client sets forth the menu or navigational component for the computer-readable medium using a combination of core functionality components for the computer-readable medium.

4. The computing system of claim 1, wherein the workflow client is set forth in XML program instructions.

5. The computing system of claim 1, wherein the editing environment for a workflow client file is a graphical user interface.

6. The computing system of claim 1, wherein the editing environment for a workflow client file forms a portion of a media authoring system.

7. A computer-implemented method of creating a computer-readable medium, comprising:
a. creating an editing environment for a workflow client file;
b. accepting user input to create and edit the workflow client file;
c. accepting user input and associating one or more asset files with the workflow client file; and
d. recording the workflow client file and the one or more asset files onto a computer-readable medium in an appropriate format to be interpreted and played back by a media player.

8. The method of claim 7, wherein the workflow client provides a menu or a navigational component for a computer-readable medium.

9. The method of claim 8, further comprising setting forth the menu or navigational component for the computer-readable medium using a combination of core functionality components for the computer-readable medium.

10. The method of claim 7, further comprising setting forth the workflow client in XML program instructions.

11. The method of claim 7, further comprising setting forth the editing environment for a workflow client file as a graphical user interface.

12. The method of claim 7, further comprising setting forth the editing environment for a workflow client file as a portion of a media authoring system.

13. A computer-readable medium, comprising instructions for causing a computer to execute the method of claim 7.

14. A method of updating a media player menu or navigational component, comprising:
a. Receiving a computer-readable medium;
b. Comparing a workflow client file on the computer-readable medium to a workflow client file on an online resource; and
c. If the workflow client file on the computer-readable medium is not as recent as the workflow client file on the online resource, then downloading the workflow client file from the online resource to a local storage area on the media player,
d. Such that the workflow client file controls a display of menu and navigational components for a computer-readable medium for playback in a media player.

15. The method of claim 14, wherein the workflow client file from the online resource further references at least one asset previously referenced by the workflow client file on the computer-readable medium.

16. The method of claim 14, wherein the workflow client file from the online resource further references at least one asset not previously referenced by the workflow client file on the computer-readable medium.

17. The method of claim 14, further comprising comparing a workflow client file on the computer-readable medium to a workflow client file stored in a local storage, and if the workflow client file on the computer-readable medium is not as recent as the workflow client file on the local storage, then using the workflow client file from the local storage to control the display of menu and navigational components.

18. A computer-readable medium, comprising instructions for causing a computer to execute the method of claim 14.

19. A media player system:
a. a processor;
b. memory in communication with the processor bearing computer-readable instructions capable of reading a workflow client file from a computer-readable medium;
c. memory in communication with the processor capable of storing the workflow client file;
d. memory in communication with the processor bearing computer-readable instructions capable of causing the media player system to access an online resource to determine if a more recent version of the workflow client file is available; and
e. memory in communication with the processor bearing computer-readable instructions capable of, if a more recent version of the workflow client file is available, causing the media player system to replace the workflow client file from the computer-readable medium with the workflow client file from the online resource.

20. The system of claim 19, wherein the workflow client file from the online resource further references at least one asset previously referenced by the workflow client file on the computer-readable medium.

21. The system of claim 19, wherein the workflow client file from the online resource further references at least one asset not previously referenced by the workflow client file on the computer-readable medium.

22. The system of claim 19, further comprising memory in communication with the processor bearing computer-readable instructions capable of, if a more recent version of the workflow client file is available in a local storage, causing the media player system to replace the workflow client file from the computer-readable medium with the workflow client file from the local storage.
